(19) United States
(12) Patent Application Publication
(10) Pub. No.: US 2016/0091132 A1
(43) Pub. Date: Mar. 31, 2016

(54) METHOD OF SUPPORTING INTAKE PIPE FOR DEEP SEAWATER

(71) Applicant: HITACHI, LTD., Tokyo (JP)

(72) Inventors: Koji SUZUKI, Tokyo (JP); Tomohiro YOSHIDA, Tokyo (JP); Kazuo KASHIDA, Tokyo (JP)

(21) Appl. No.: 14/857,268

(22) Filed: Sep. 17, 2015

(30) Foreign Application Priority Data
Sep. 30, 2014 (JP) 2014-201935

(51) Int. Cl. F16L 57/00; F16L 55/24; F16L 1/20; F16L 1/16; F16L 1/24

(52) U.S. Cl. CPC F16L 57/005; F16L 1/163; F16L 1/24; F16L 1/201; F16L 55/24

(57) ABSTRACT

A method of supporting an intake pipe for deep seawater, the intake pipe being made of resin having a smaller specific gravity than the deep seawater, the method including: mooring at least a neighborhood part of an intake port of the intake pipe with a plurality of mooring devices (e.g., pendant-type anchors) each including a mooring wire (e.g., wire rope) and a heavy weight (e.g., concrete block); and mooring the neighborhood part of the intake port in the form of an arc directed to the sea surface.

### CROSS-REFERENCE TO RELATED APPLICATION

This application is based upon and claims the benefit of priority to the Japanese Patent Application No. 2014-201935, filed on Sep. 30, 2014, the entire contents of which are incorporated herein by reference.

### BACKGROUND OF THE INVENTION

1. Field of the Invention

The present invention relates to a method of supporting an intake pipe for deep seawater.

2. Description of the Related Art

Facilities for intake of deep seawater have been in operation at ten and several places domestically, and besides have been put into practice in France, the United States of America, South Korea,

Taiwan and the like. Domestic facilities of them are primarily intended for industrial use of deep seawater (fishery, agriculture, food, bottled water and the like). Moreover, in order to prevent breakage of an intake pipe due to typhoons and/or earthquakes originating from the geographical features, an iron wire (steel tape)—armored high density polyethylene pipe has been adopted which is a resin pipe reinforced with an iron wire or a steel sheet. This pipe is heavy in weight and thus is laid on the seafloor without requiring a special weight such as a concrete weight. Furthermore, in order to prevent sand from being mixed into the pipe, the intake port needs to be raised upward from the seafloor. For this purpose, the intake port is supported on a steel support structure, and examples thereof include a six-sided pyramid-shaped intake port and a three-sided pyramid-shaped intake port.

The six-sided pyramid-shaped intake port is suited for a terrain having a steep seafloor slope at a location where the intake port is placed. The end portion of the intake pipe is located at the center of the bottom face of the six-sided pyramid. The three-sided pyramid-shaped intake port makes it possible to be placed at a higher location from the seafloor surface because the end portion of the intake pipe is located at the vertex of the three-sided pyramid, but extreme care must be taken to perform attitude control at the time of placement.

On the other hand, the facilities in the United States and France adopt a high density polyethylene pipe (HDPE pipe) as the intake pipe. The HDPE pipe is smaller in specific gravity than seawater and thus is submerged to be placed on the seafloor with a concrete weight being attached thereto at the time of laying. Note that the intake port is raised upward from the seafloor with a steel or concrete support structure in many cases.

Patent Document 1 (Japanese Patent Application Publication No. 2000-087579, FIG. 2) discloses supporting the neighborhood of an intake port of a resin intake pipe for deep seawater with a support member (e.g., a wire or the like) via a support structure placed on the seafloor.

When the intake port is supported on the steel support structure, a sacrificial electrode is generally used so as to avoid corrosion of the steel used in the support structure. Such a sacrificial electrode employs material having a stronger ionization tendency than iron and thus the sacrificial electrode is caused to corrode to avoid corrosion of the steel. The size of the sacrificial electrode is designed depending on designed lifetime, but after the designed lifetime, corrosion of the steel begins. Deep seawater intake facilities are required to realize a stable operation over a long period of time as social infrastructure, and accordingly, use of metallic material which is easy to corrode needs to be reduced to the extent possible.

In Patent Document 1, when the resin intake pipe is used, the intake port of the intake pipe is supported in the horizontal direction, and besides there is no description as to details of the neighborhood of the intake port of the intake pipe.

Moreover, since the intake port of the intake pipe is placed at a location of several hundred meters from the sea surface, there has been the necessity of considering the behavior of deep-water fish and the like.

### SUMMARY OF THE INVENTION

The present invention has been made to solve the above problems and makes it an object thereof to provide a method of supporting an intake pipe for deep seawater which, when laying a resin intake pipe, facilitates the laying and simplifies the laying method.

In order to achieve the above object, the present invention provides a method of supporting an intake pipe for deep seawater, the intake pipe being smaller in specific gravity than the deep seawater, the method including: mooring at least a neighborhood part of an intake port of the intake pipe with a plurality of mooring devices each including a mooring wire (e.g., a wire rope 3a) and a heavy weight (e.g., a concrete block 3b); and mooring the neighborhood part of the intake port in the form of an arc directed to the sea surface. Other aspects of the present invention will be described in embodiments as described later.

According to the present invention, when laying a resin intake pipe, the laying can be facilitated and the laying method can be simplified.

### BRIEF DESCRIPTION OF THE DRAWINGS

FIG. 1 is a system diagram showing an intake pipe for deep seawater according to an embodiment of the present invention.

FIGS. 2A and 2B are explanatory views showing a neighborhood part of an intake port for deep seawater according to the present embodiment.

FIGS. 3A and 3B are explanatory views showing relationships between the intake port and behavior in swim of deep-water fish.

FIGS. 4A and 4B are explanatory views showing laying conditions of an intake pipe in a comparative example and the intake pipe in the present embodiment.

FIG. 5 is an explanatory view showing a laying method of an intake pipe in the case of an obstacle existing on the seafloor.

### DETAILED DESCRIPTION OF THE EMBODIMENTS

Embodiments of the present invention will be hereinafter described in detail with reference to the accompanying drawings.

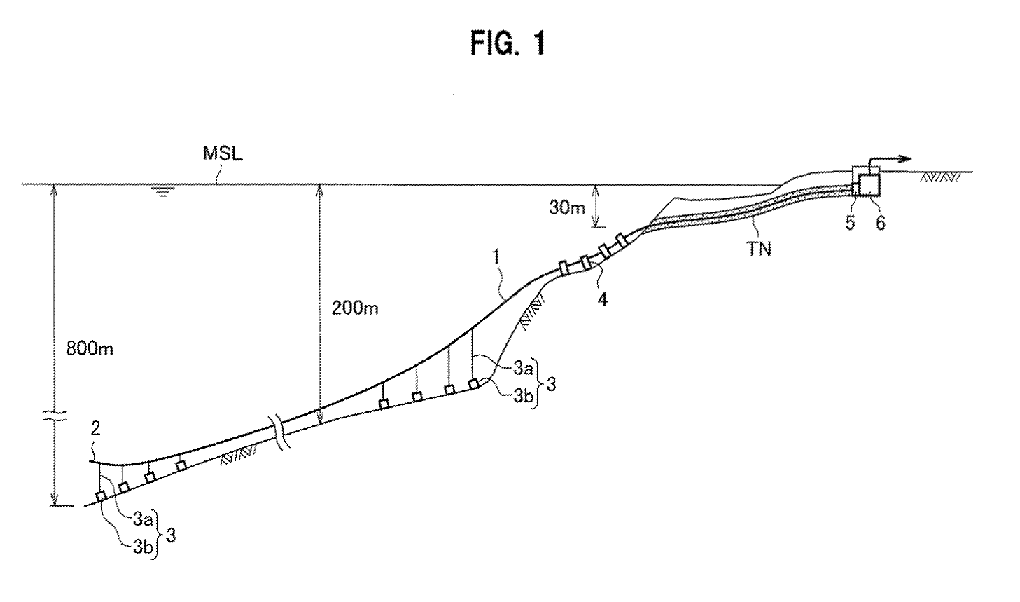

FIG. 1 is a system diagram showing an intake pipe for deep seawater according to an embodiment of the present invention. In the present embodiment, an intake pipe 1 for deep seawater is a high density polyethylene pipe (HDPE pipe) having a bore of approximately 900 millimeters, which extends from the land approximately 3 kilometers offshore and extends from a mean sea level MSL of the ocean until a depth of approximately 800 meters. Deep seawater is pumped up by an intake pump 6 through the intake pipe 1 and a strainer 5. The deep seawater pumped up is fed to, for example, a heat exchanger and the like. The strainer 5 is a filter for not allowing fish and shellfish, which have entered from an intake port 2, to go into the intake pump 6 to damage it.

A part of the intake pipe 1, which lies at approximately 30 meters or less below sea level, is laid in a tunnel TN. Further, the intake pipe 1 is laid to extend from the end of the tunnel TN to a place of depth at which deep seawater is pumped up. The intake pipe 1 is made of resin having a smaller specific gravity than seawater and thus generates buoyant force under the sea.

For this reason, at the time of laying the intake pipe 1 on the seafloor, a concrete weight 4 is generally attached to the intake pipe 1 to fix the intake pipe 1 to the seafloor. However, since there is a risk that foreign matter such as sand on the seafloor is mixed into the intake pipe 1 when the intake port 2 is fixedly held at a location close to the seafloor, the intake port 2 is preferably placed at a height of approximately 10 meters from the seafloor.

As a method of holding the intake port 2 at a fixed height, the present embodiment includes using a plurality of pendant-type anchors 3 (mooring devices) each including a wire rope 3a (mooring wire) and a concrete block 3b (heavy weight) to support the intake port 2 in a suspended state under the sea. Thus the plurality of pendant-type anchors 3 are used to properly adjust (lengthen gradually toward the seafloor in the illustrated example) respective lengths of the wire ropes 3a, thereby making it possible to keep a one-way slope toward the land.

Moreover, even where the seafloor has a steep incline at which a depressed spot exists (e.g., at approximately 200 meters below the mean sea level MSL), the plurality of pendant-type anchors 3 are used to lay the intake pipe 1, thereby making it possible to perform the laying without bending the intake pipe 1.

The present embodiment includes using the pendant-type anchors 3 constituted by the wire ropes 3a and the concrete blocks 3b and laying the lightweight resin pipe (intake pipe 1) having a smaller specific gravity than seawater, in a suspended state under the sea. Several pendant-type anchors 3 are used in conformity with the slope of the seafloor, thereby allowing the intake port 2 to be held at a fixed height from the seafloor while keeping a rising slope toward the land from the intake port 2. The intake port 2 is suspended in a free state under the sea, but is brought into a nearly motionless state after placement of the intake port 2 because the intake port 2 is not subjected to influence by waves or tidal current at a water depth, e.g., 800 meters where it is placed, and thus there is little undersea current.

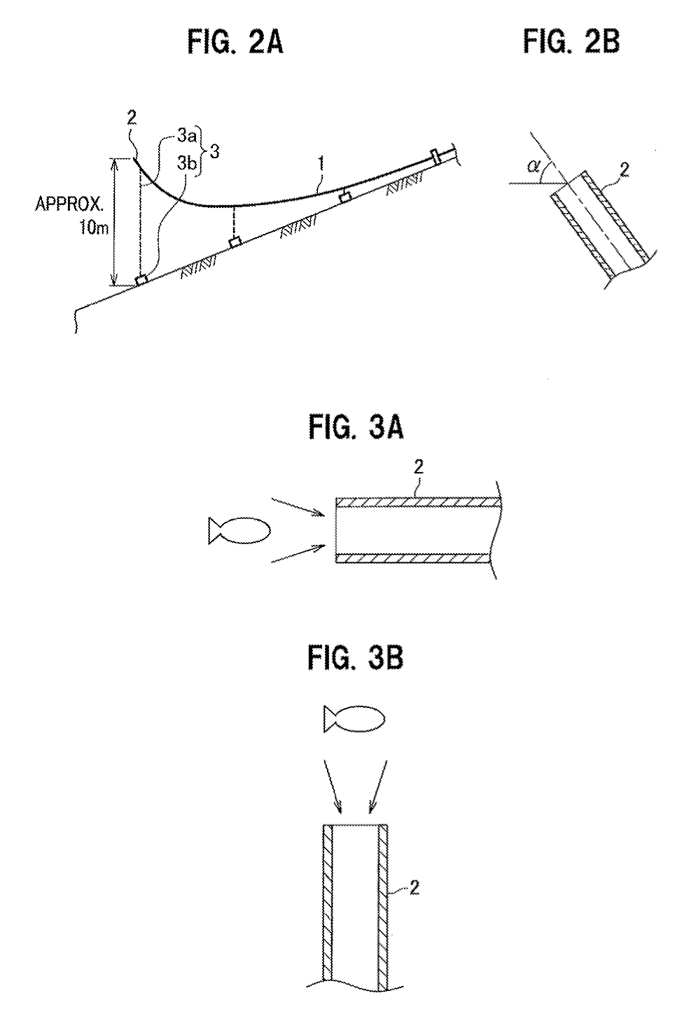

FIGS. 2A and 2B are explanatory views showing a neighborhood part of an intake port for deep seawater according to the present embodiment. FIG. 2A is an enlarged view of the neighborhood part of the intake port 2, and FIG. 2B is a view depicting an angle of an end portion of the intake port 2. Respective lengths of the wire ropes 3a of the pendant-type anchors 3 are changed according to the slope of the seafloor, thereby making it possible to properly change an angle α to a horizontal plane of the end portion of the intake port 2. The intake port 2 is placed upward in the form of an arc from the land-side, which makes it physically difficult to set the angle α to 90 degrees (vertical). In view of this, the lengths of the wire ropes 3a are adjusted to set an intake direction of the end portion of the intake port 2 so that the angle α is about 30 degrees to 70 degrees, thereby realizing an environment which makes fish difficult to be mixed into the intake pipe 1.

FIGS. 3A and 3B are explanatory views showing relationships between the intake port and behavior in swim of deep-water fish. FIG. 3A shows the case where the intake port is arranged in the horizontal direction, and FIG. 3B shows the case where the intake port is arranged in the vertical direction. The inventors' research shows that deep-water fish (e.g., Beryx splendens, Pristiophorus japonicas) has a tendency to conform the axis of the body to a direction of current so that resistance against the current is reduced. Accordingly, in the case of the intake port 2 being in the horizontal direction shown in FIG. 3A, there is a possibility that fish moves into a current to enter the intake pipe 1. On the other hand, in the case of the intake port 2 being in the vertical direction shown in FIG. 3B, fish needs to take an unusual position in the vertical direction so as to conform the body to the current, and consequently it is difficult for the fish to enter the intake pipe 1.

Taking into account a curvature for bending of the high density polyethylene pipe (HDPE pipe) and a surfacing force of the HDPE pipe, the angle α can be set to be about 30 degrees to 70 degrees.

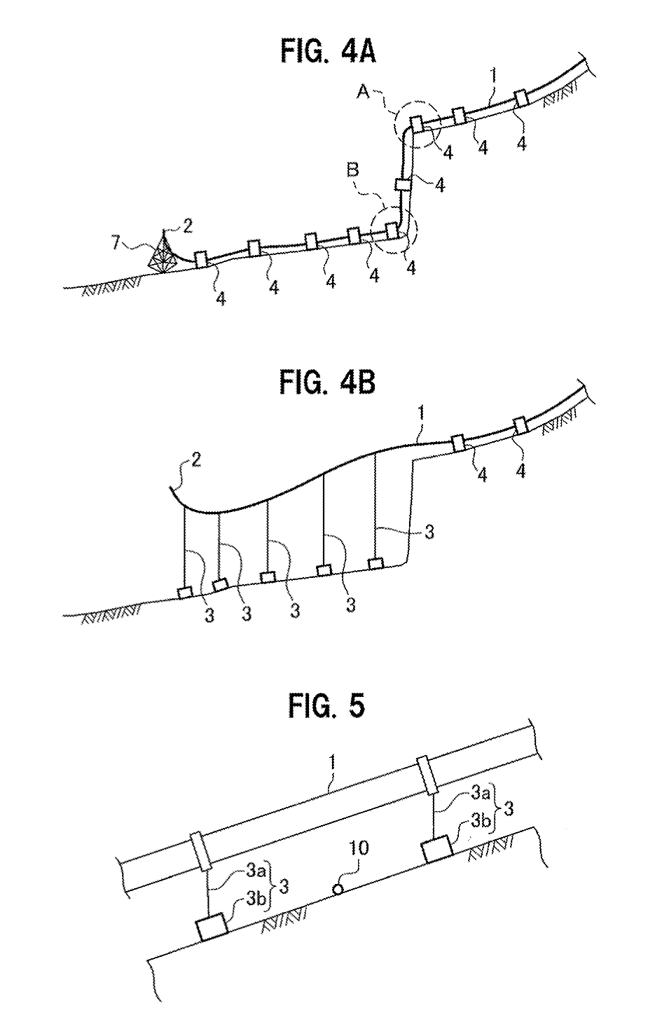

FIGS. 4A and 4B are explanatory views showing laying conditions of an intake pipe in a comparative example and the intake pipe in the present embodiment. FIG. 4A is a view showing a laying condition of the intake pipe in the comparative example, and FIG. 4B is a view showing a laying condition of the intake pipe in the present embodiment. In the comparative example shown in FIG. 4A, where the seafloor has a difference in height, there is a risk that the intake pipe 1 is extremely bent at portions indicated by reference signs A and B thereof, depending on locations of the concrete weights 4 attached to the intake pipe 1. Also, a three-sided pyramid-shaped intake port 7 makes it possible to be placed at a higher location from the seafloor surface because the intake port 2 which is the end portion of the intake pipe 1 is located at the vertex of the three-sided pyramid, but extreme care must be taken as to whether attitude at the time of placement is rightly directed.

On the other hand, in the case of the present embodiment shown in FIG. 4B, since the plurality of pendant-type anchors 3 are used to lay the intake pipe 1, the laying can be easily performed without bending the intake pipe 1 even where the seafloor has a difference in height. Moreover, the neighborhood part of the intake port 2 is moored in the form of an arc directed to the sea surface and thus the laying can be facilitated.

FIG. 5 is an explanatory view showing a laying method of an intake pipe in the case of an obstacle existing on the seafloor. Even where an obstacle, for example, a submarine cable 10 exists on the seafloor, the intake pipe 1 is laid using the plurality of pendant-type anchors 3, thereby producing an advantageous effect in that no damage is given to the submarine cable 10 at the time of the laying.

Since the present embodiment uses the pendant-type anchors 3, the intake pipe 1 to be supported is surely suspended at locations distanced from the concrete blocks 3b by respective lengths of the wire ropes 3a in the vertical direction, irrespective of placement attitude of the concrete blocks 3b. Accordingly, compared with the conventional supporting method using a steel support structure, placement work for the intake port 2 can be simplified. Moreover, since metallic material is less used, applying resin coating to the wire ropes 3a and parts such as bolts makes it possible to avoid a risk of corrosion without using a sacrificial electrode. This supporting method is effective even where irregularity such as rocks exists on the seafloor, or even where an existing structure such as a submarine pipe or cable exists on the seafloor to cause a resin pipe to be laid stepping over the existing structure. Furthermore, in areas with a small risk of typhoons and/or earthquakes, a high density polyethylene (HDPE) pipe with a large bore suitable for large capacity may be adopted. According to the present embodiment, a simpler and more reliable laying method can be realized.

### DESCRIPTION OF REFERENCE SIGNS

1: Intake pipe, 2: Intake port, 3: Pendant-type anchor (Mooring device), 3a: Wire rope (Mooring wire), 3b: Concrete block (Heavy weight), 4: Concrete weight, 5: Strainer, 6: Intake pump, 7: Three-sided pyramid-shaped intake port, TN: Tunnel

What is claimed is:

1. A method of supporting an intake pipe for deep seawater, the intake pipe being smaller in specific gravity than the deep seawater, the method comprising:
mooring at least a neighborhood part of an intake port of the intake pipe with a plurality of mooring devices each including a mooring wire and a heavy weight; and
mooring the neighborhood part of the intake port in the form of an arc directed to the sea surface.

2. The method of supporting an intake pipe for deep seawater, according to claim 1, wherein respective lengths of the mooring wires are adjusted so that an angle from a horizontal plane toward a direction of the sea surface, of an intake direction of an end portion of the intake port, is set within a range of 30 degrees to 70 degrees.

3. The method of supporting an intake pipe for deep seawater, according to claim 1, wherein when an obstacle exists on the seafloor, the intake pipe is moored with a plurality of mooring devices each including a mooring wire of a predetermined length.

4. The method of supporting an intake pipe for deep seawater, according to claim 1, wherein each of the mooring devices includes a concrete block and a wire rope.
